(19) United States
(12) Patent Application Publication
(10) Pub. No.: US 2016/0071113 A1
(43) Pub. Date: Mar. 10, 2016

(54) Evidence Assessment Systems and Interactive Methods

(71) Applicant: PRMA Consulting Ltd., Fleet (GB)

(72) Inventors: Sotiria Papanicolaou, Marousi (GR); Fraser Rutherford, York (GB); David Sykes, Fleet (GB); Casey Quinn, Northampton, MA (US); Jonathan Spinage, Bicester (GB); Steven Fountain, Gateshead (GB)

(73) Assignee: PRMA Consulting Ltd., Fleet (GB)

(21) Appl. No.: 14/481,334

(22) Filed: Sep. 9, 2014

(51) Int. Cl. G06Q 30/00

(52) U.S. Cl. CPC G06Q 30/018

(57) ABSTRACT

A method for assessing evidence includes receiving a user request to summarize an ability of the evidence to satisfy agency requirements of one or more agencies. Each of the one or more agencies has a plurality of evidence requirements categorized into one or more domains of a plurality of pre-defined domains. For each combination of an agency from the one or more agencies and a domain from the plurality of the domains, a visual indicator reflecting the ability of the evidence to satisfy at least one evidence requirement of the agency in the domain is generated. An interactive map comprising the generated visual indicators arranged by agencies and domains is rendered on a display device. The interactive map is configured such that a selection of a visual indicator on the map causes information related to the visual indicator to be rendered on the display device.

### FIELD OF THE INVENTION

Embodiments of this invention relate generally to systems and interactive methods for assessing evidence against various evidence requirements.

### BACKGROUND OF THE INVENTION

Introduction into a market of certain types of products, such as new drugs or medical technologies, usually requires manufacturers to perform a number of steps, including seeking approval of a regulatory body which would evaluate products' safety, efficacy, and/or quality before approving their use. If a manufacturer desires to seek funding or reimbursement for its product, it must meet further requirements before being able to launch and market the product. For example, in the context of pharmaceutical products and medical technologies, such additional requirements may include effectiveness, safety, budget impact, and cost-effectiveness. Thus, manufacturers need to collect evidence concerning medical, social, economic, and ethical implications of the new drug or medical technology, which are then systematically evaluated by a respective agency(ies) or payer(s) at a national, sub-national, or regional level. This formal evaluation of the evidence against pre-set requirements is known as a Health Technology Assessment (HTA).

Although different HTA agencies undertake some rm of HTA evaluation, their funding approval and reimbursement decisions vary considerably, even when reviewing similar evidence concerning the same new drug or medical technology. In other words, HTA requirements often differ significantly among different HTA agencies. Such diversity poses enormous challenges for applicants, particularly when the applicant seeks to introduce its product into multiple markets and/or a global company with multiple affiliates to which it needs to provide evidence relevant to submissions in their respective countries/regions. As financial constraints on healthcare systems grow more acute and technologies in the medical and healthcare industries advance, new HTA agencies are created and new, different evidence requirements come into effect. Further, the evaluation methods and evidence requirements keep evolving, including the introduction of new requirements and criteria that the manufacturer needs to meet. Thus, applicants are faced with a formidable task of setting strategies for gathering evidence and evidence assessment in readiness for HTA submissions.

Therefore, there is a need for systems and methods that would facilitate evaluation and re-evaluation of current evidence and evidence generation plans against HTA requirements in order to highlight and/or prioritize product-specific critical success factors for such submissions and to identify evidence gaps at both affiliate (country) and global levels. There is further need for systems and methods that would facilitate evidence evaluation and re-evaluation in a concise and interactive manner and enable collaboration between global and affiliate bodies in terms of evidence generation.

### BRIEF SUMMARY

The invention is generally directed to assessing evidence against various evidence requirements.

In one aspect, a computer-implemented method for assessing evidence is provided. The method includes receiving a user request to summarize the ability of the evidence to satisfy agency requirements of one or more agencies. Each of the one or more agencies has a plurality of evidence requirements categorized into one or mare domains of a plurality of pre-defined domains. The method further includes generating, for each combination of (1) an agency from the one or more agencies and (2) a domain from the plurality of the domains, a visual indicator reflecting the ability of the evidence to satisfy evidence requirement(s) of the agency in the domain. The method also includes rendering, on a display device, an interactive map comprising the generated visual indicators arranged by agencies and domains, wherein the interactive map is configured such that the selection of a visual indicator on the interactive map causes information related to the visual indicator to be rendered on the display device.

In another aspect, an evidence assessment computing device is provided. The device includes a display; one or more processors; memory; and one or more programs stored in the memory and configured to be executed by the one or more processors to perform a method for assessing evidence. The method includes receiving a user request to summarize an ability of the evidence to satisfy agency requirements of one or more agencies. Each of the one or more agencies has a plurality of evidence requirements categorized into one or more domains of a plurality of pre-defined domains. The method further includes generating, for each combination of (1) an agency from the one or more agencies and (2) a domain from the plurality of the domains, a visual indicator reflecting the ability of the evidence to satisfy evidence requirement(s) of the agency in the domain. The method also includes rendering, on a display device, an interactive map comprising the generated visual indicators arranged by agencies and domains, wherein the interactive map is configured such that the selection of a visual indicator on the interactive map causes information related to the visual indicator to be rendered on the display device.

Methods, systems, devices, and graphical interfaces for assessing evidence against various evidence requirements, substantially as shown in and/or described in connection with at least one of the figures, as set forth more completely in the claims, are disclosed. Various advantages, aspects, and novel features of the present disclosure, as well as details of an exemplary embodiment thereof, will be more fully understood from the following description and drawings.

### BRIEF DESCRIPTION OF THE DRAWINGS

Embodiments of the present invention will be described, by way of example only, with reference to the accompanying drawings, in which:

FIG. 1 shows a block diagram depicting a client-server based system suitable for deployment of the present invention in accordance with some embodiments;

FIG. 2 shows a high-level block diagram of a computing system suitable for implementing the present invention according to some embodiments;

FIG. 3 depicts a flow diagram of a method for assessing the ability of the evidence to satisfy selected evidence requirements, according to some embodiments of the present invention;

FIG. 4 shows an example of a graphical user interface for an evidence assessment system, according to some embodiments of the present invention;

FIG. 5 depicts a flow diagram of a method for setting up an evidence assessment system, according to some embodiments of the present invention;

FIG. 6 depicts a flow diagram of a method for summarizing evidence assessment results, according to some embodiments of the present invention;

FIG. 7 depicts a flow diagram of an interactive method for assessing evidence, according to some embodiments of the present invention; and

FIGS. 8A, 88, and 8C show examples of an interactive user interface for an evidence assessment system, according to some embodiments of the present invention.

### DETAILED DESCRIPTION

Embodiments of the invention provide methods and systems for assessing evidence. In particular, the disclosed methods and systems deliver an interactive, collaborative, user-friendly tool for assessing the ability of the evidence to satisfy pre-set requirements, such as for HTA submissions. The tool provides its user with broad and detailed overviews of evidence readiness, aiding the user with gap analysis at both the global and affiliates levels, allowing strategic planning and development of recommendations on how to bridge identified gaps. The tool illustrates evidence assessment results concisely and effectively, providing the user with fast and efficient access to key data and without requiring the user to sift through a magnitude of evidence and/or requirements. The disclosed tool, according to embodiments of the invention, is also a technological platform for effective strategic planning, communication, and collaboration between a global office and affiliates that sets a framework for consistent approaches and standardized outputs, including assessment and prioritization of evidence generation requirements at global and local levels.

Embodiments according to the invention are described below primarily with reference to the evidence assessment for HTA submissions. Although this is a particularly preferred application of the disclosed embodiments, the embodiments are in no way restricted to this application. In particular, the context of HTA submissions is illustrative of the complexity of the evidence and requirements handled by the disclosed methods and systems. The described embodiments and the described techniques are more generally applicable to assessing the ability of the evidence to satisfy a multitude of various requirements, including overlapping requirements and requirements of different levels. Therefore, embodiments according to the invention are not limited by the specific embodiments depicted in the figures and, rather, are limited only by the scope of the claims that follow.

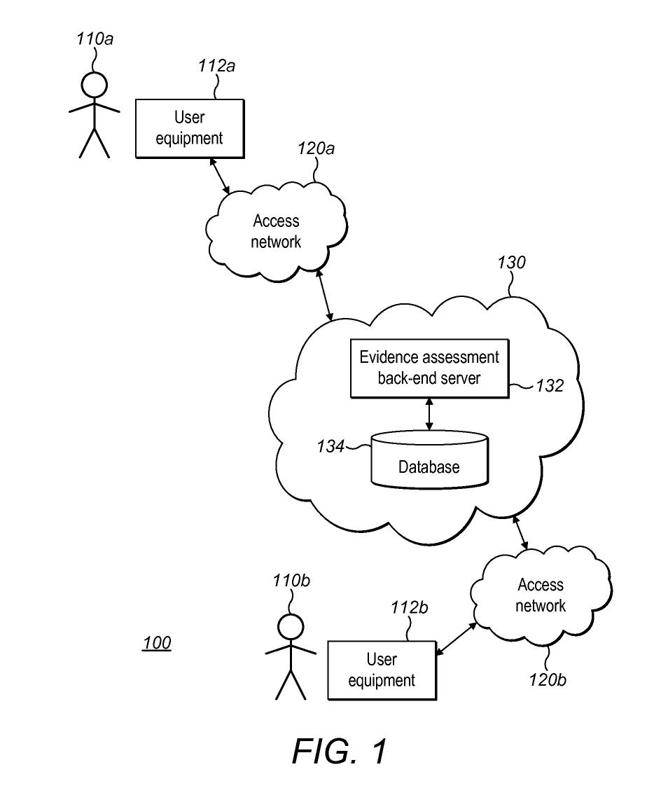

FIG. 1 is a block diagram depicting a client-server based system 100 suitable for deployment of embodiments of the present invention. The client-server based system 100 enables the roles and responsibilities of the system to be distributed among several independent computer platforms that are coupled only through a network or a plurality of networks. It generally employs two types of nodes: clients (such as a user equipment 112a or 112b) and servers (such as an evidence assessment back-end server 132).

The system 100 may include any type of communications network, such as an Internet Protocol (IP) network (e.g., an IP Multimedia Subsystem (IMS) network, an asynchronous transfer mode (ATM) network, a wireless network, a cellular network, a long term evolution (LTE) network, and the like), broadly defined as a network that uses Internet Protocol to exchange data packets. Additional IP networks include Voice over IP (VoIP) networks, Service over IP (SoIP) networks, and the like. The system 100 may include a single network or combination of networks. Each client or server connected to the network may also be referred to as a “node.”

In some embodiments, the system 100 comprises a core network 130, which hosts the back-end server 132 and is in communication with one or more access networks 120a and 120b through which clients, such as the user equipment 112a and 112b are able to communicate with the back-end server 132. The access networks 120a and 120b may include a wireless access network (e.g., a WiFi network and the like), a cellular access network, a cable access network, a wired access network such as a local area network (LAN) or a wide area network (WAN), and the like. The access networks 120a and 120b may be different types of access networks, the same type of access network, or some access networks may be the same type of access network and other access network may be different types of access networks. Each of the access networks 120a and 120b and the core network 130 may be a single network or a combination of networks. Further, different service providers, the me service provider, or a combination thereof may operate the core network 130, the access network 120a, and/or the access network 120b.

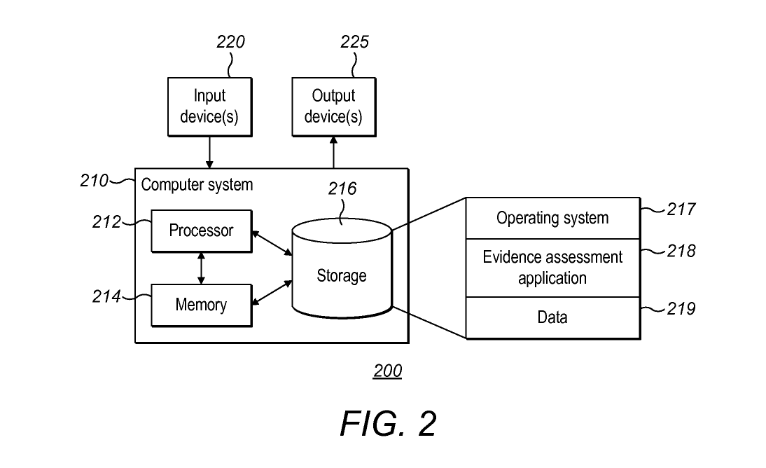

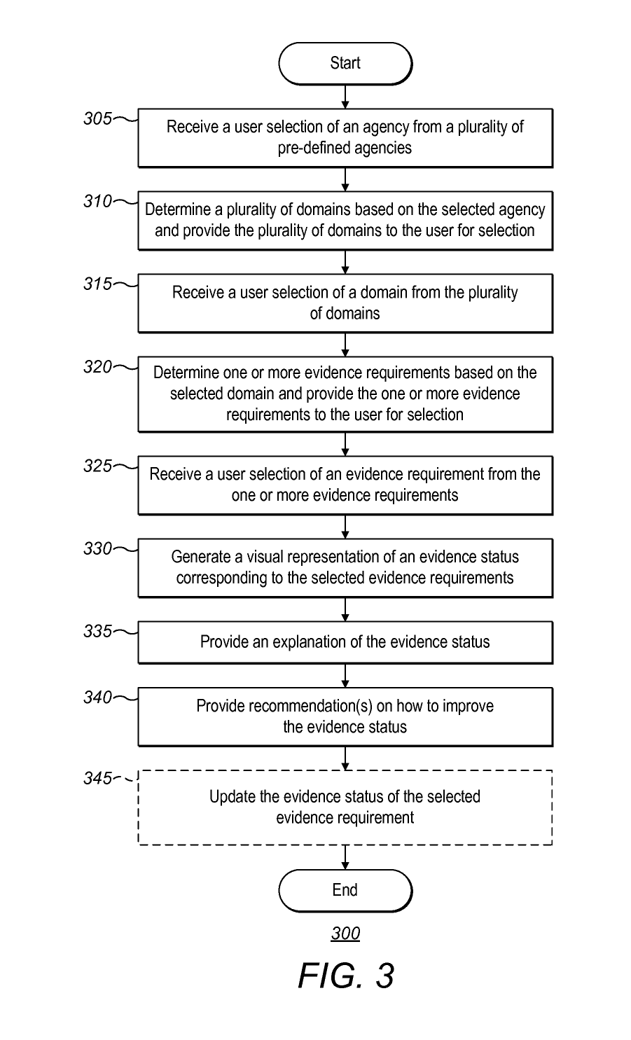

In some embodiments, the back-end server 132 includes an evidence assessment module that includes program instructions executable by a computer system to perform some or all of the functionalities described herein with respect to the evidence organization and assessment services. The evidence assessment module may include program instructions that are executable by the server 132 to perform some or all of the steps of methods for assessing evidence as described with respect to FIGS. 3 to 8C. In some embodiments, the back-end server 132 is supported by a computer system, such as the system illustrated in FIG. 2 and described below.

The server 132 includes a network (back-end) entity, implemented for example by the evidence assessment module, which serves requests of client entities, such as the user equipment 112a and 112b (also referred to as UE, user devices, or endpoint devices). In some embodiments, the server 132 hosts a content site, e.g., a website, a file transfer protocol (FTP) site an Internet search website and/or other source of network content, which the client entities may access via the Internet. The server 132 may include web server(s), database server(s), and/or an email server(s).

The core network 130 also hosts a database 134 or a similar data repository that supports the back-end server 132 and stores data related to the evidence assessment services supported by the evidence-assessment back-end server 132, such as client gathered evidence, evidence gathering plans, evidence status(es), and/or the like. and/or information about users of the evidence assessment system 100. In some embodiments, these and other data are stored in encrypted form so as to protect the information of and associated with the users of the evidence assessment system. User authorization may be required for the users to access the services provided by the evidence-assessment back-end server 132, including to store, update, request, or provide any information associated with the users and evidence.

Although only a single back-end server 132 and database 134 are shown in FIG. 1, any number of such server(s) and/or database(s) and/or similar systems may be deployed. The server(s), database(s), and/or system(s) may be deployed individually or in combination. In some embodiments, the core network 132 comprises a portion of a cloud environment in which services and applications are supported in a highly distributed manner.

As described herein, devices UE 110a and 110b are in communication with the back-end server 132 via the access networks 120a and 120b respectively. The UE 110a and 110b are any type of endpoint device that is capable of accessing services from a service provider (cellular, Internet, and the like). That is, the UE 110 may be a device from a variety of electronic devices including, but not limited to, a desktop computer, a mobile endpoint device such as a cellular telephone, a smart phone, a tablet computer, a laptop computer, a netbook, a head-up display device (e.g., a head mounted display) a portable media device, a personal digital assistant (PDA), and/or the like.

The devices 110a and 110b may include various input/output (I/O) interfaces, such as a graphical user interface (e.g, a display screen, a touch screen), an image acquisition device (e.g., a camera), an audible output user interface (e.g., a speaker), an audible input user interface (e.g., a microphone), a keyboard, a pointer/selection device (e.g., a mouse, a trackball, a touchpad, a touch-screen, a stylus, etc.), a printer, or the like. The devices 110a and 110b may further include computing components and/or embedded systems optimized with specific components for performing specific tasks, such as tasks related to the evidence assessment services. In some embodiments, the devices 110a and 110b host an evidence assessment application including one or more modules having program instructions that are executable by the devices 110a and 110b to perform some or all of the functionalities described herein with regard to FIGS. 3 to 8C. In some embodiments, the devices 110a and 110b include a computer system similar to that of computer system 200 described with respect to FIG. 2. In some embodiments, the evidence assessment application is web-based with the user accessing all data at the back-end 132 using a web browser run by a UE.

Although only two user devices are illustrated in FIG. 1, any number of such devices may be deployed and supported by the system 100. For example, more than one UE may be in communication with the core network 130 via a single access network, e.g., 120b. Such UEs may represent independent users of the services provided by the evidence assessment back-end server 132, or some or all of the UEs may represent a single user (e.g., a user having multiple devices, a company having multiple access points to the system) and/or affiliates associated with a single global company. The UEs may also form or be included into a local network that is in communication with the access network, e.g., 120b.

This architecture of the system 100 allows computing devices of UEs to share files and resources. Each instance of the client evidence assessment module can send data requests to the back-end server 132. In turn, the back-end server 132 can accept these requests, process them, and return the requested information to the client. In some embodiments, all data is stored on the server platform (e.g., in the database 134) in order to provide for greater security controls than what most clients could provide.

The system shown in FIG. 1 has been simplified and many elements have been omitted from the figure. For example, the system 100 may include other network elements (not shown) such as border elements, routers, switches, policy servers, security devices, a content distribution network (CDN) and the like as are known to those in the art.

FIG. 2 is a high-level block diagram of a computing system 200 suitable for implementing some embodiments of the present invention disclosed herein. The system 200 is suitable to be deployed as a back-end server, such as the evidence assessment back-end server 132 illustrated in and discussed with respect to FIG. 1, and/or a user endpoint device, such as the UE 112a and 112b also illustrated in and discussed with respect to FIG. 1. It should be understood that embodiments of the invention could be implemented as a physical device or a subsystem that is coupled to a processor through a communication channel. Therefore, in some embodiments, the system 200 comprises a processor 212, a memory 214, a storage 216, and various input/output (I/O) devices 220 and 225, such as a display, a keyboard, a mouse, a modem, a microphone, speakers, a touch screen, an adaptable I/O device, and the like. In some embodiments, at least one I/O device is a storage device (e.g., a hard disk drive, an optical disk drive, a floppy disk drive, a flash drive, and the like).

The processor 212 may include a single processor device and/or a plurality of processor devices (e.g., distributed processors). A processor may be any suitable processor capable of executing/performing instructions and includes a central processing unit (CPU) that carries out program instructions to perform the basic arithmetical, logical, and input/output operations of the computing system 200. The processor 212 may include code (e.g., processor firmware, a protocol stack, a database management system, an operating system, or a combination thereof) that creates an execution environment for program instruction and may be programmable. The processor 212 may include general and/or special purpose microprocessors.

The processor 212 receives its instructions and data from the memory 214. The computing system 200 may include a single processor only, or be a multi-processor system including any number of suitable processors, which provide for parallel and/or sequential execution of some or all functionalities described herein. Processes and logic flows described herein may be performed by one or more programmable processors executing one or more computer programs to perform functions by operating on input data and generating corresponding output. The computing system 200 may include a computer system employing a plurality of computer systems (e.g., distributed computer systems) to implement various processing functions.

Further, the client and/or the server portion of the evidence assessment system may be implemented as one or more software applications, or a combination of software and hardware, e.g., using Application Specific Integrated Circuits (ASIC)), where the software is loaded from a storage medium (e g., I/O devices 220, 225) and operated by the processor 212 in the memory 214 of the computing system (or device) 200. Thus, for example, the evidence assessment module (client or server) described herein with reference to FIG. 1 can be stored on a tangible or non-transitory computer readable medium (e.g., RAM, magnetic, flash, or optical drive, external drive, or diskette, and/or the like).

The evidence assessment results and control of data by the user, in some embodiments, are provided via a user interface of the computing system 200 using I/O devices 220 and 225, such as a display, a touch screen, a keyboard, a mouse, and/or the like.

The computing system 200 ludes a network interface (not shown), such as a network adapter that provides for connection of the computing system 200 to a network, wired and/or wireless. Generally, the network interface facilitates data exchange between the computing system 200 and other devices connected to the same network.

A person skilled in the art will appreciate that the computing system 200 is merely illustrative and is not intended to limit the scope of the techniques described herein. It may include any combination of devices and/or software that may perform or otherwise provide for the performance of the techniques described herein. In addition, the functionality provided by the illustrated components may in some embodiments be combined in fewer components or distributed in additional components. Similarly, in some embodiments, the functionality of some of the illustrated components may not be provided and/or other additional functionality may be available.

FIG. 3 depicts a flow diagram of a method 300 for assessing evidence against selected evidence requirement(s), according to some embodiments. The method is generally executed when a client (manufacturer, applicant, global or affiliate, or the like) seeks to analyze the ability of the gathered evidence (quantity and quality) to satisfy evidence requirement(s) of a selected agency in a selected domain (or a sub-domain)—for a selected agency and domain combination—and/or determine what further projects and/or actions should be pursued. The method may be executed at the client side, e.g., at the UE 112 described with respect to FIG. 1, or remotely, for example, at the back-end server 132 described with respect to FIG. 1, such as in a web-based implementation.

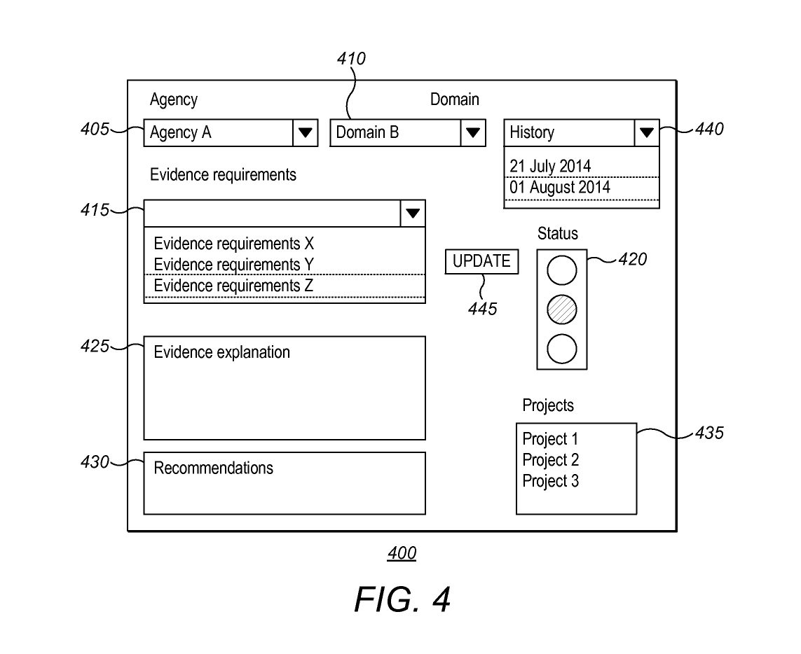

The method 300 starts with step 305 at which step a selection by a user of an agency is received, The agency is generally an entity, such as a country, a region, a market, a regulatory board, and/or the like that sets out or has a number of evidence requirements, e.g., an HTA agency. The user's selection may be received, for example, via a user interface of the evidence assessment system installed on the client side such as on a UE. As shown in FIG. 4, in some embodiments, the user selects a desired agency from a drop down menu 405 of a user interface 400.

In some embodiments, certain requirements, such as regulatory requirements, are combined under a heading of a separate agency or considered to be equivalent to an agency. In other words, although such requirements do not necessarily correspond to any real agency, the system combines such requirements and treats them as though they were issued by an ‘agency,’ which is available for user's selection at step 305.

Once the evidence assessment system registers the user's selection of a particular agency, it determines a plurality of corresponding domains at step 310. Generally, evidence requirements set by or associated with a particular agency (e.g., agency requirements established by a UK HTA agency) are categorized into a plurality of domains (e.g., product overview, costs, cost-effectiveness, and others) and/or sub-domains (e.g., acquisition costs, costs of diagnosis and screening, choice of model comparator, and others respectively) in the evidence assessment system. Each domain (sub-domain) includes one or more evidence requirements that relate to each other, such as all evidence requirements associated with clinical trials, e.g. a summary of the methodology of relevant randomized control trials (RCTs), an assessment of the quality of the included RCTs, results for all outcome measure(s) relevant to the decision problem, details of all important adverse events for each intervention group, etc. Not each domain necessarily includes sub-domains. Although the system is generally designed to provide for uniform domains, sub-domains, and evidence requirements for all agencies, where possible, not all agencies have their evidence requirements categorized into the same domains/sub-domains and not all agencies have evidence requirements associated with all domains/sub-domains, and not all evidence requirements are shared between different domains/sub-domains and/or agencies.

When the plurality of domains/sub-domains associated with the selected agency is identified, such domains/sub-domains are presented to the user for selection at step 310, for example using a dropdown menu 410 of the user interface 400 shown in FIG. 4. In the embodiments of the evidence assessment system that employs domains and sub-domains, different dropdown menus may be presented to the user, with the sub-domain drop down menu being presented or populated after the user selects a particular domain.

Returning to FIG. 3, at step 315, a selection by the user of a particular domain from the plurality of the presented domains is received. As discussed above, each domain includes a plurality of associated evidence requirements. Although different agencies may share the same evidence domains, evidence requirements within a particular domain may differ for different agencies. At step 320, evidence requirements associated with the combination of the selected domain and selected agency (or in other words, evidence requirements of the selected agency in the selected domain) are determined and provided to the user for selection, for example using a dropdown menu 415 of the user interface 400 shown in FIG. 4. At step 325 of the method 300, a selection by the user of a particular evidence requirement from the presented evidence requirements is received.

Using this succession of the interactive exchanges with the evidence assessment system described with respect to steps 305 to 325, the user is able to efficiently access and determine the ability of the evidence to satisfy a particular selected evidence requirement. As stated above, such exchanges may be facilitated by employing dropdown menus of the system user interface, such as the user interface 400 of FIG. 4. In some embodiments, the dropdown menus are presented to the user one by one as the user makes his/her selections of an agency first, then of a domain/sub-domain, and then finally of a particular evidence requirement. In some embodiments however, the dropdown menus are presented to the user simultaneously, where, once the user makes a selection in one of the dropdown menus, the content of the remaining dropdown menus is filtered or populated accordingly, For example, the user may select to start his/her selection by selecting a domain or a particular evidence requirement. By allowing the user to choose a dropdown menu to start the selection, the user is provided with flexibility in the search for desired information, such as the ability of the evidence to satisfy a particular evidence requirement, agency, and/or domain.

Yet in some embodiments, the system allows the user to select more than one item from the dropdown menu(s). For example, the user may wish to assess the ability of the evidence to satisfy a particular evidence requirement that is shared by a plurality of agencies. As different agencies may use different criteria to determine whether a particular evidence requirement (e.g., a requirement for cost-effective analysis) is satisfied, the user may start his or her selection with a particular evidence requirement, and then select all agencies that have the selected evidence requirement. In this scenario, the domain/sub-domain may be automatically selected, if the selected evidence requirement corresponds to a single domain/sub-domain, or requires a user's selection if the selected evidence requirement corresponds to more than one domain/sub-domain.

A person skilled in the art would appreciate that dropdown menus shown in FIG. 4 are merely illustrative, and other user interface widgets may be employed as long as they provide for the same functionality of enabling the user to make his/her selection of an agency, a domain/sub-domain, and/or an evidence requirement, whether substantially simultaneously or in turn.

Returning to FIG. 3, at step 330, the system generates a visual indicator (representation or the like) indicating a status of the ability (readiness) of the evidence to satisfy the evidence requirement selected by the user at step 325. The user interface 400 of FIG. 4 provides an example of such an indicator, i.e., item 420. As shown in FIG. 4, in some embodiments, the visual indicator is in the form and shape of a 3-light traffic light, each light identifying one of 3 statuses: (1) evidence fully satisfies the selected evidence requirement (e.g., green); (2) evidence partially satisfies the selected evidence requirement (e.g., amber); and 3) evidence does not satisfy the selected evidence requirement (e.g., red). Depending on the status reflection the ability of the evidence to satisfy the selected evidence requirement, the displayed traffic light is displayed with the red, amber, or green light being on.

Different kinds of visual indicators may however be used to indicate a status of the evidence including, but not limited to, using a spectrum of colors, numbers, and/or words, a thermometer, different shapes, concentric circles, colors, words, and/or others. The visual indicator may be static or animated. In some embodiments, the evidence assessment system allows the user to select and set a preferred method and/or appearance for indicating statuses of the ability of the evidence to satisfy evidence requirement(s).

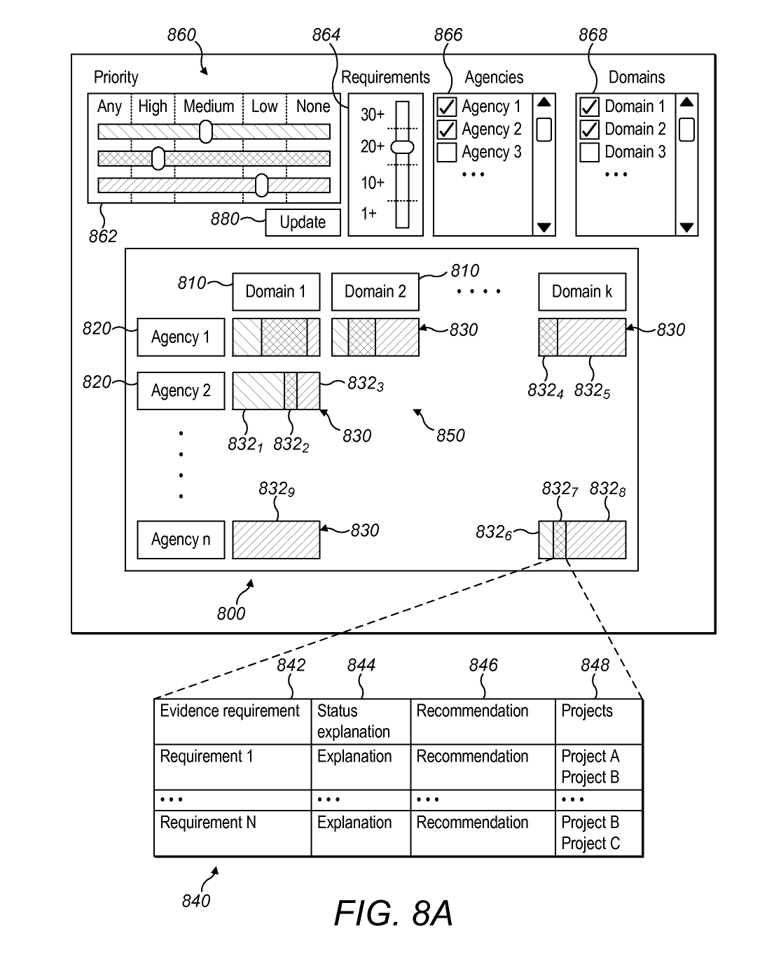

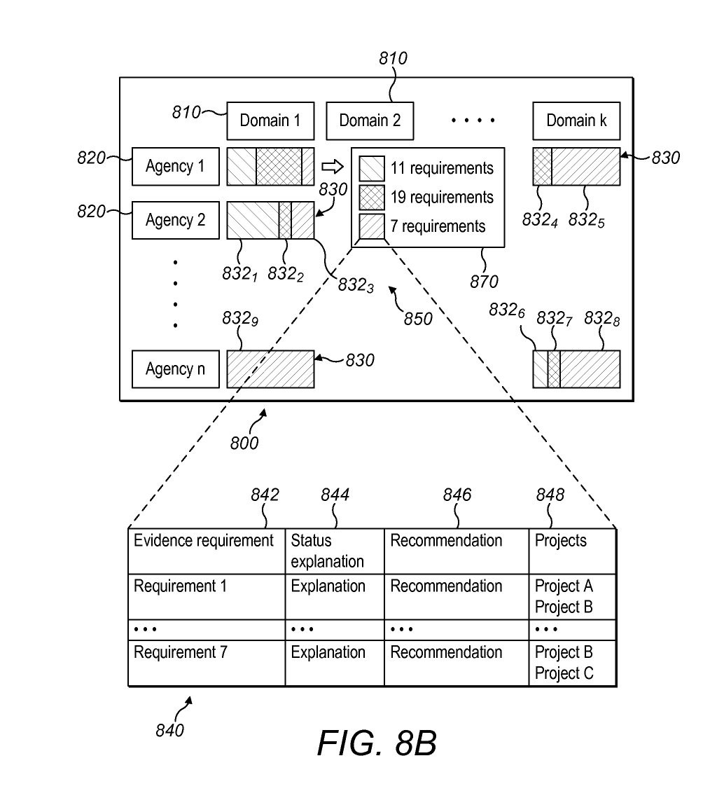

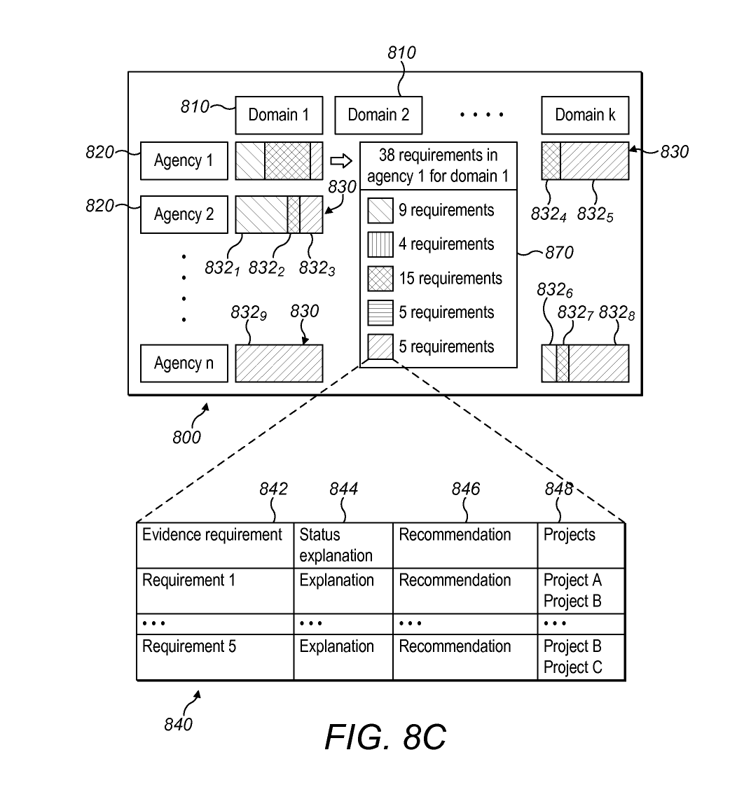

Further, although the example provided above with respect to FIGS. 3 and 4 employs only three possible statuses, a smaller (e.g., two) or a greater (e.g., 4, 5, 6, etc.) number of evidence statuses may be used to indicate how able, qualitatively and/or quantatively, the evidence is to satisfy a particular evidence requirement. As discussed in greater detail below with respect to FIGS. 8A to 8C, in some embodiments, a plurality of ranking systems for ranking the ability of the evidence to satisfy evidence requirement(s) may be used in parallel, to provide for a general, broad overview and a more detailed view.

Additionally, in some embodiments, when a user selects more than one evidence requirement, agency, and/or domain (sub-domain) for displaying an evidence status, instead of displaying respective statuses for each selected combination, a single status determined based on the plurality of statuses is displayed, e.g., by averaging the plurality of statuses. For example, if the user selects two evidence requirements for a particular combination of an agency and a domain and the status of the ability of the evidence to satisfy one requirement requires a green indicator and to satisfy the other evidence requirement requires a red indicator, an amber indicator is displayed. In a further example, a spectrum of colors is used, with each color having a corresponding numerical value and each status having a corresponding color. A resulting status—color is then determined by averaging the numerical values corresponding to the plurality of the statuses and selecting a color from the spectrum that corresponds to the calculated average numerical value, or to the numerical value that is the closest to the calculated value and is included into the spectrum,

In some embodiments, in addition to the evidence status, a corresponding status explanation is displayed (presented, or otherwise provided) to the user at step 335, for example, in a respective window of the system's user interface, such as a window 425 of the user interface 400 of FIG. 4. This explanation generally identifies what evidence is being evaluated in relation to the selected evidence requirement and how such evidence is evaluated to determine the status of the evidence, and/or the like.

In some embodiments, at step 340, the user is also provided with some suggestions (recommendations) concerning how the status of the ability of the evidence to satisfy the evidence requirement may be improved, such as what evidence should be gathered, by whom, at what time period, what projects to be performed, in what order, and the like. The user interface may include a respective window to display or otherwise provide such recommendations, e.g., a window 430 of the user interface 400 of FIG. 4.

At step 345 of the method 300, the status of the evidence is updated, for example, when an indication is received that the additional relevant evidence has been obtained. Such a step is not necessary to enable the evidence assessment and may be omitted in some embodiments of the invention. However, this step provides for the system update when, for example, additional evidence has been gathered and/or evidence requirements have changed.

In some embodiments, the evidence assessment system includes functionality for enabling the user to update the status of the ability of the evidence to satisfy a particular evidence requirement, a status explanation, and/or projects linked to the evidence requirement. For example, after the user is provided with the visual indicator, for example, in the manner described with respect to steps 305 to 340, the user may decide that it is necessary to update the evidence status. This decision may be based on changes in the evidence that has not yet been entered into the system, such as new evidence generation plans that have been put in place, a particular plan for evidence generation has been realized, criteria for a particular evidence requirement have changed, a particular evidence gathering plan failed, and/or the like. In accordance with some embodiments, the user may initiate the update process by selecting an update button 445 of the user interface 400.

In response to the user's initiation of the update process, another user interface screen (not shown) may be displayed to the user, where the user is allowed to select a new status for the ability of the evidence to satisfy the selected evidence requirement of the selected agency and domain combination, enter a new status explanation, and/or update, add, or remove one or more projects linked to the selected evidence requirement. To prevent the user from changing the status unwarrantedly and/or unwittingly, in some embodiments, certain safeguards are implemented in the evidence assessment system, such as requiring the user to enter an explanation for changing the status and/or submitting the status update for approval before the system would finalize the status change.

In some embodiments, when the user wishes to upgrade the evidence status to the next level, the user is presented with a checklist of, or generally corresponding to, the recommendations provided concerning the status improvement in the window 430. Once, the user checks all or some of the points on the checklist (e.g., at the user's discretion), the user is allowed to update the evidence status. In some embodiments, however, the system nonetheless automatically sends a request to approve the status update to a pre-defined entity, e.g., to an administrator, a global user when an affiliate user initiates the status update, and/or any other pre-defined entity. Once the approval is received, the system finalizes the status update. In some embodiments, certain pre-defined parties and/or users are automatically informed by the system concerning any changes in the evidence status and/or other changes.

In some embodiments, any updates, such as changes to the evidence status, addition of evidence, and the like are saved (logged) as history, which is then made available to the user in respect to relevant evidence requirements. Once the user selects a particular agency, domain/sub-domain, and evidence requirement combination, in addition to the evidence status, the user is also provided with the relevant history, e.g., via a dropdown menu with dates identifying when the changes were made, such as a dropdown menu 440 shown in FIG. 4.

In some embodiments, users of the evidence assessment system may be provided with different authorities. For example, if the evidence assessment system is used by a global office and its affiliates, users of the global office may be allowed to make changes with respect to any agencies, while affiliates may be allowed to make changes only with respect to their corresponding agencies. Further, some users may have authority to make changes without seeking approval, while other users may only have authority to propose changes/updates, which then are finalized only after such changes/updates have been approved, e.g., by a party having the right to approve the changes.

A person skilled in the art would appreciate that the dropdown menu 440 shown in FIG. 4 is merely illustrative, and other user interface widgets may be employed to provide the user with access to the relevant history. For example, in some embodiments, the user is provided with a history button, selection of which opens a dialogue box (as an overlay or a new window) that allows the user to select among the dates of when respective changes were made After the user selects a particular date, a respective form (e.g., similar to the display in FIG. 4) is populated to show what changes were made on the selected date. Such changes may be provided in a separate window or as an overlay.

As already discussed with respect to FIG. 3, FIG. 4 shows an example of a user interface of the evidence assessment system. Such a user interface enables the user to interact with the evidence assessment system, for example during execution of the method 300 described with respect to FIG. 3.

In addition to the already discussed above user interface components, the user interface 400 includes a project window 435 for displaying/identifying evidence projects (e.g., clinical trial data collection, monitoring of a treatment landscape, etc.) related to the selected evidence requirement. In some embodiments, the projects window 435 is interactive and enables the user to select one of the displayed project(s). In response to such a selection, the user is displayed (for example, in a separate screen or as an overlaying screen) other evidence requirements that require the selected project to be performed.

In some embodiments, the displayed projects are ordered in accordance of their importance or value in relation to the selected evidence requirement. For example, project(s), successful completion of which would improve the ability of the evidence to satisfy the evidence requirement to a greater extent than any other project, could be listed first, while project(s), successful completion of which is, although beneficial, not critical to the ability of the evidence to satisfy the selected evidence requirement, could be listed last, with the remaining projects graded and listed in between. Further, in some embodiments, the system enables the user to access all the projects corresponding to all or selected evidence requirements of all or selected agencies and/or domains and access priority of all projects available for completion in a similar manner.

In some embodiments, the projects displayed in the window 435 are ordered in accordance of their importance and/or value as they are provided to the user. In some other embodiments, the system orders the projects in accordance with their importance only upon receiving a user's request, such as if a designated button is engaged. Further, in some embodiments, only projects that are deemed important are displayed in the window 435, such as upon a user's request.

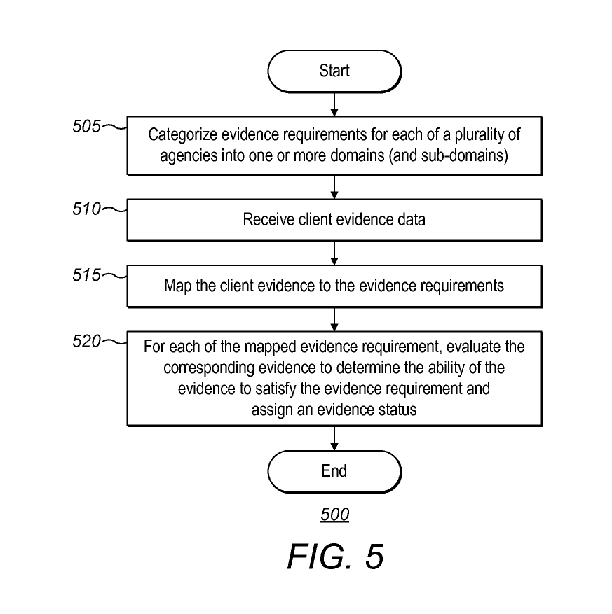

FIG. 5 depicts a method 500 for setting up (initializing) an evidence assessment system, according to some embodiments. The method is typically performed at the back-end of the system, such as at the back-end server 132 described with respect to FIG. 1. The method starts with step 505, at which step agencies' evidence requirements are categorized into domains and/or sub-domains. Each agency has a number of pre-defined evidence requirements that need to be satisfied for the agency to grant an approval, such as an approval for funding or reimbursement. The agency may also have criteria, pre-defined and/or customary (developed with practice), that it uses to evaluate applicants' evidence against the pre-defined requirements. Different agencies may have different evidence requirements and/or criteria. However, typically, there is at least some overlap between different agencies.

At step 505, the evidence requirements are categorised into domains and sub-domains, where each domain/sub-domain groups together related evidence requirements. For example, all evidence requirements associated with cost effectiveness, such as “description of the economic model; whether interventions and comparators are implemented in the model as per their marketing authorization, CE marking and doses, explanation of how the clinical data were implemented in the model,” etc., may be grouped into a single domain. Some domains may be further categorized into sub-domains, such as when some evidence requirements are sufficiently related to form a single domain, but also sufficiently different to form its own sub-category within the domain. Preferably, the agencies' evidence requirements are categorized into uniform domains/sub-domains, where possible. Step 505 is typically performed at the initial stage of setting-up the system for use by a plurality of different clients. However, step 505 may also be performed when the evidence system requires updating (re-setting, tuning), for example, when a new agency needs to be added, evidence requirements for a particular agency change, and the like. The evidence assessment system includes a user interface that allows a system administrator or other user to categorize evidence requirements and update such categories as needed.

At step 510, client evidence is received. Such evidence may include, but is not limited to, evidence that the client gathered with the goal of satisfying some or all evidence requirements for some or all agencies, evidence that was developed and/or gathered for some other projects, evidence available in a public domain, plans to gather evidence, lack of evidence, and the like. For example, evidence data provided by the client may include clinical trials data for a particular trial. In some embodiments, commonly accessible relevant evidence, and not necessarily the client's evidence, may be added to the received evidence. for example, published evidence, publicly accessible researches by universities and other entities, competitors' evidence, and the like.

At step 515, the received evidence is mapped to the evidence requirements of the evidence assessment system. Evidence requirements, corresponding pre-defined and/or customary criteria, pre-developed strategies, and/or the like are used to map the evidence. In certain scenarios, the same evidence may be mapped to multiple evidence requirements, agencies domains, or sub-domains. For example, evidence from a randomized controlled trial may be mapped to several domains, such as clinical trials, patient reported outcomes, cost-effectiveness, etc. However some evidence may only be mapped to a single evidence requirement, for example, the details of a products mechanism of action would only be mapped to the corresponding requirement on “Evidence on the mechanism of action.”

At step 520, for each evidence requirement, the mapped evidence is evaluated to assess its ability to satisfy that requirement. Based on the results of the evaluation, an evidence status is assigned. If no evidence or plans to gather evidence are mapped to a particular evidence requirement, a respective status indicating that no work has yet been done to satisfy that requirements is assigned. Pre-defined or customary criteria corresponding to the evidence requirement, pre-developed strategies, and the like may be used to make the evidence assessment and determine the evidence status. Once the step 520 is completed, the evidence assessment system is set-up and ready to be used by a client.

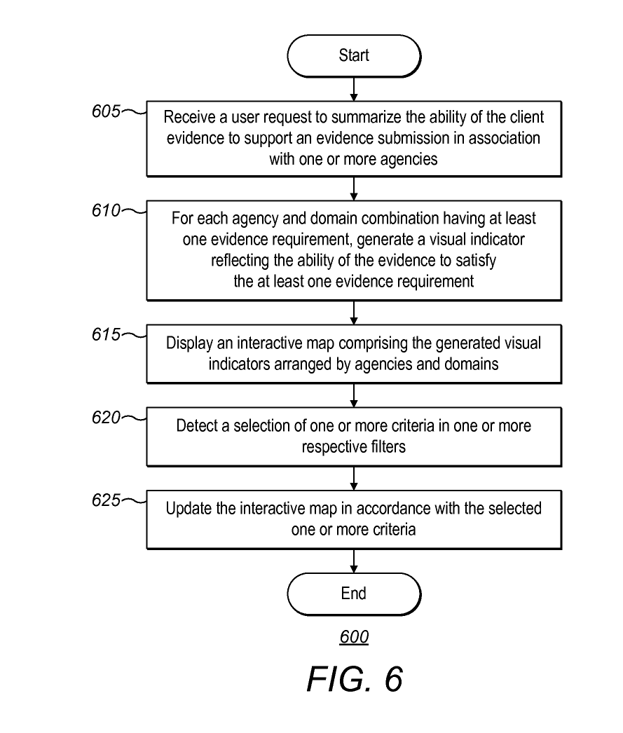

FIG. 6 depicts a flow diagram of a method 600 for summarizing evidence assessment results, according to some embodiments. The method 600 starts with step 605 of receiving a user request to assess client's evidence in association with one or more agencies and summarize the evidence assessment. In some embodiments, the user submits such a request via the user interface of the evidence assessment system, e.g., using, an assigned button. In some embodiments, the user is also enabled to identify the one or more agencies e.g., using a dropdown menu, for which he or she wishes the summary to be prepared. If the user selects no agency(ies), the evidence assessment system interprets the user request to relate to all agencies present in the evidence assessment system. Alternatively, a default selection of certain agencies may be used.

At step 610, the evidence assessment system determines and/or generates a visual indicator for each agency and domain combination. For example, if the evidence assessment system supports two agencies, such as A and B, and each agency has two evidence domains, such as C and D, four visual indicators will be generated, i.e., for each of the AC, AD, BC, and BD combinations. Each visual indicator indicates the ability of the evidence to satisfy all evidence requirements associated with the respective agency and domain pair (combination). In other words, a determined/generated visual indicator for an agency and domain combination is designed to indicate the ability of the evidence to satisfy all evidence requirements of the agency in that domain. A different indicator may be used to identify agency and domain combinations that have no corresponding evidence requirements. In some embodiments, no visual indicator is generated or displayed for the agency and domain combinations that have no corresponding evidence requirements.

A visual indicator may reflect a plurality of evidence statuses. For example, if a particular combination of an agency and a domain has multiple associated evidence requirements and the existing evidence satisfies such requirements with different success levels, or in other words different agency's evidence requirements in the domain are associated with different evidence statuses, the visual indicator includes all such different evidence statuses. However, if all evidence requirements associated with a particular agency-domain combination have the same evidence status, the visual indicator reflects a single evidence status only. When a visual indicator reflects a plurality of statuses, in some embodiments, the visual indicator is designed to reflect the proportional relationship between the evidence requirements of different requirements with respect to the agency-domain combination (discussed in greater detail with respect to FIGS. 8A to 8C).

At step 615, an interactive map is generated and displayed to the user. The interactive map generally comprises all generated/determined visual indicators that are arranged by agencies and domains and such identified by respective agency and domain indictors (e.g., domains 810 and agencies 820 in FIG. 8A). If the user selected only certain agencies and/or domains at the time of submitting the request to summarize the evidence, the map includes visual indicators only for the selected agencies and domains. In some embodiments, the interactive map is generated, based on a pre-set template and determined visual indicators. In some embodiments, the interactive map is generated by combining the generated visual indicators, where such indicators are interactive.

The map is interactive as it enables the user to select a particular visual indicator and access data/information concerning the corresponding evidence status. As discussed herein, in some embodiments, the user is provided with such data on different levels, such as a broad overview and a more detailed view. Further, the interactive map allows the user to jump to (access) a specific agency, domain, sub-domain, and/or evidence requirement upon a respective selection of the specific agency, domain, sub-domain, and/or evidence requirement. Furthermore, the user is able to select a particular agency or domain indicator, thus causing the system to display all corresponding evidence requirements in a separate window, as an overlay, next to the interactive map, etc.

In some embodiments, the user is enabled to filter information (data) included in (shown on) the map. For this purpose, the user interface may include one or more filter widgets that allow the user to select one or more criteria for updating the interactive map. For example, the user may wish to see statuses of the evidence only for evidence requirements that have a certain (e.g., high) priority, or for selected agencies only. At step 620, the selection by the user of one or more criteria via one or more filter widgets is detected. In some embodiments, the user selection is detected as soon as the user adjusts one of the filters. In some other embodiments, the evidence assessment system captures user's selections in one or more filter widgets only when the user engages a specifically assigned button or some other specifically assigned user interface component.

At step 625, the interactive map is updated in accordance with the selected one or more criteria. For example, if the user selects only certain agencies, the interactive map is updated to summarize the evidence for the selected agencies only. In some embodiments, the map is updated to display visual indicators that satisfy the selected criteria. Yet in some other embodiments, the visual indicators satisfying the selected criteria are emphasized in relation to the visual criteria that do not satisfy the selected criteria. The visual indicators may be emphasised in a variety of ways including, but not limited to, using border(s), increasing contrast around visual indicators matching the selected criteria and/or decreasing contrast around visual indicators that do not match the selected criteria, using different sizes for the visual indicators matching and not matching the selected criteria, bringing the visual indicators matching the selected criteria forward and/or pushing the visual indicators that do not match the selected criteria backwards, using animation, using overlays (such as displaying the visual indicators matching the filter criteria as an overlay or using an overlay to emphasize such visual indicators), and the like. The interactive map and associated functionalities are further discussed with respect to FIGS. 8A to 8C.

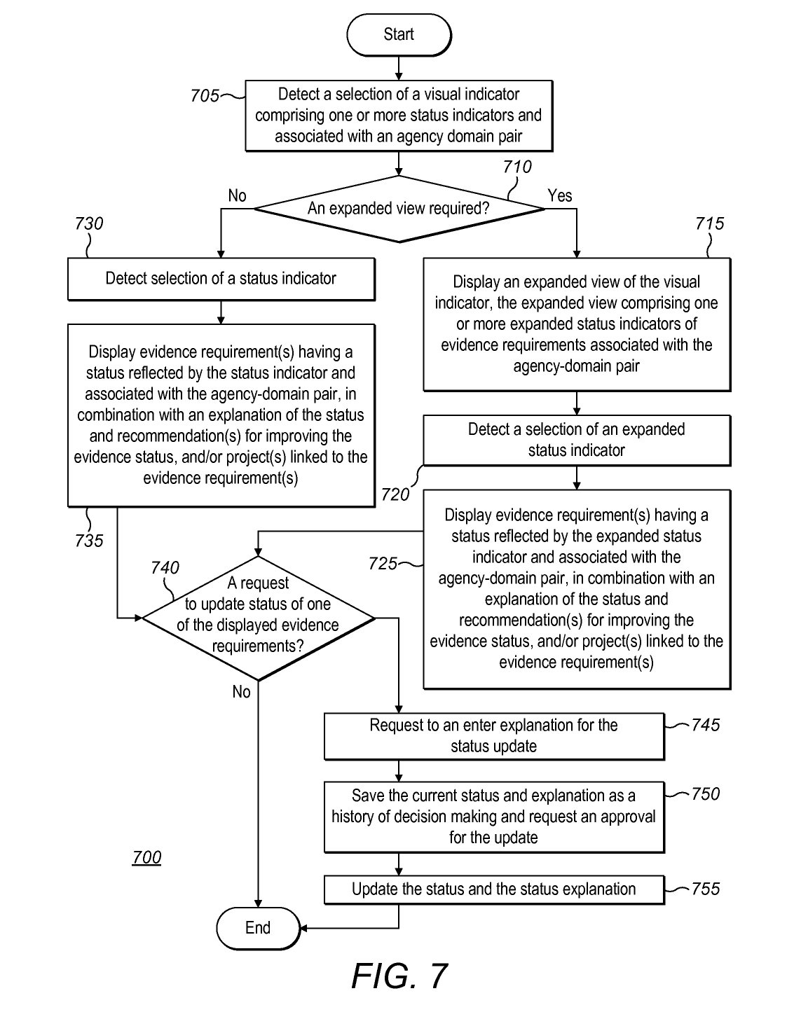

FIG. 7 depicts a flow diagram of an interactive method 700 for assessing evidence, according to some embodiments of the present invention. The method 700 starts with step 705, at which step a user selection of a particular visual indicator is detected on the interactive map of the evidence assessment system. As discussed with respect to FIG. 6, the selected visual indicator includes one or more evidence status indicators.

At step 710, a determination is made concerning whether an expanded view is required. In some example embodiments, the determination is made based on the type of the user input, e.g., a touch gesture or a mouse selection and/or click. For example, it may be harder for the user to be precise while using a touch screen and his or her finger. The expanded view facilitates a user's selection of a particular evidence status indicator. In some embodiments, the expanded view is provided to give a more detailed view of statuses of the evidence readiness with respect to a particular agency-domain combination. In some embodiments, the user sets a respective parameter within the evidence assessment system if he or she desires the evidence system to provide the expanded view functionality.

If no expanded view is required, at step 730, the user selection of a particular evidence status indicator within the selected visual indicator is detected. For example, in some embodiments, a determination of which particular evidence status indicator the user has selected is based on a position within the screen area occupied by the interactive visual indicator where the user's input is detected (e.g. a touch gesture, mouse click, and/or the like). In some embodiments, such a determination is made at step 705 discussed above.

At step 735, evidence requirements having the status identified by the selected evidence status indicator are displayed to the user. If the corresponding domain includes a plurality of sub-domains, in some embodiments, the evidence requirements are displayed in association with their respective sub-domains. Additionally, a status explanation and/or recommendation(s) for improving the evidence status may be displayed as well. Further, evidence projects associated with each displayed evidence requirement are displayed in some embodiments. The user is able to select one of the selected projects to determine all evidence requirements associated with that project (such as evidence requirements that require the project to be performed), enter an update on the project, and the like.

At step 740, a request to update the evidence status for one of the displayed evidence requirements may be received from the user. For example, in some embodiments, a specifically assigned button for submitting such a request is included in the user interface. In some other embodiments, when the user selects a particular evidence requirement displayed in association with the selected agency-domain combination, a user is provided with an option to update a corresponding status, such as by right-clicking a mouse, via an overlay pop-up window, and the like.

If the request to update the evidence status is received, in some embodiments, at step 745, a request to enter an explanation for the status update is issued to the user, e.g., in an overlay pop-up window, a separate window, or some other user interface widget. When an explanation is entered, the updated status and the corresponding explanation are saved in an associated updates history and the status update is submitted for approval to a pre-defined entity. Once the approval has been granted, the status and the status explanation are updated in accordance with the request, at step 755.

If, at step 710, a determination is made that an expanded view is required, at step 715, the expanded view of the visual indicator is displayed to the user. In some embodiments, such a view comprises one or more expanded status indicators indicating the status of the ability of the evidence to satisfy the evidence requirements associated with the agency-domain combination corresponding to the selected visual indicator. As discussed herein in greater detail, the expanded view may comprise the same evidence statuses displayed in an enlarged manner, additional details, such as the number of evidence requirements corresponding to each displayed evidence status (such as shown in FIG. 8A, item 870), sub-domains corresponding to the evidence requirements and/or the like. Further, the expanded view may include a greater number of the evidence statuses (such as shown in FIG. 8B, item 870), with or without additional information, for example, an explanation (a more detailed view for a particular visual indicator).

At step 720, a user selection of an evidence status indicator within the expanded view is detected. For example, in some embodiments, determination of which particular evidence status indicator the user has selected is based on a position within screen area occupied by the visual indicator where the user's input is detected (e.g., a touch gesture, mouse click, and/or the like).

At step 725, evidence requirements having the status identified by the selected evidence status indicator are displayed to the user. Additionally, a status explanation and/or recommendation(s) for improving the evidence status may be displayed as well. Further, evidence projects associated with each displayed evidence requirement are displayed in some embodiments. The projects may be ordered in accordance to their importance in the manner discussed with respect to FIG. 4. The user is able to select one of the selected projects to determine all evidence requirements associated with that project, enter an update on the project, and the like. After step 725, the method 700 proceeds to step 740, which is described above.

FIGS. 8A to 8C show examples of an interactive user interface for summarizing the ability of the evidence to satisfy evidence requirements to the user. FIG. 8A displays a user interface that includes an interactive status map 800 and a plurality of filters 860 (filter widgets, gadgets, or the like) for adjusting data displayed on the interactive status map 800 (or in other words, for filtering the map),

The map 800 includes a plurality of visual indicators 830 that indicate statuses (levels) of the ability of the evidence to satisfy evidence requirements for each of the domain-agency combination supported by the system and/or selected by the user. Each row of the map corresponds to a particular agency 820, while each column corresponds to particular domain 810, where each cross-point corresponds to a particular agency and domain combination. A skilled person would appreciate that the interactive map may be differently designed, for example, agencies may correspond to columns while domains may correspond to rows.

In some embodiments, the filters 860 include a priority filter 862, a number of requirements filter 864, an agency filter 866, and a domain filter 868. Using the domain filter 868, the user may select which domains' visual indicators are to be shown in the status map 860. For example, the user may select Domain 1 and Domain 2. When the user pushes an update button 870, the status map becomes updated to display the visual indicators only in the columns corresponding to the selected domains, such as the first two columns. in some embodiments, the map is updated by removing visual indicators corresponding to non-selected domains. In some other embodiments however, the updating of the status map includes removal of the identifiers of the non-selected domains (e.g., the domain k identifier) and, optionally, resizing the map, such as by increasing the size of the visual indicators that remain displayed on the status map.

Similarly, the user may select agency(ies), for which the status map 800 should include the visual indicators. For example, the user may select Agency 1 and Agency 2. When the user pushes the update button 870, the status map is updated to display visual indicators only in the row(s) corresponding to the selected agency(ies), such as the first two rows. In some embodiments, the map is updated by removing the visual indicators corresponding to the non-selected agency(ies). In some other embodiments however, the updating of the status map includes removal of the identifiers of the non-selected agency(ies) (e.g., the agency n identifier) and, optionally, resizing the map, such as by increasing the size of the visual indicators that remain displayed on the status map.

The number of requirements filter enables the user to display visual indicators corresponding to a certain number of evidence requirements. In the illustrative embodiment of FIG. 8A, the number of requirements filter is a slider that enables the user to select a minimum number of evidence requirements corresponding to a particular domain-agency combination for which visual indicators are to be displayed. For example, if the user slides the slider to a 20+ position, only visual indicators corresponding to agency-domain combinations that each have 20 or more associated evidence requirements are displayed. In some embodiments, the slider is associated with a particular status for such evidence requirements, e.g., not satisfied. Further, in some embodiments, the number of requirements filter allows the user to specify a particular number of evidence requirements and/or a particular status.

The priority filter allows the user to filter the status map based on the priority level of the evidence requirements. Different priorities may be assigned to different evidence requirements based on, for example, a complexity of evidence required to satisfy a particular evidence requirement, a number of projects that need to be performed to satisfy a particular evidence requirement, how the ability of the evidence to satisfy a particular evidence requirement affects the ability of evidence to satisfy other evidence requirements.

In some embodiments, the priority filter 862 includes only two options: (1) to display visual indicators for all selected agencies/domains and (2) to display visual indicators only for the priority (key) evidence requirements. Such a filter is implemented, in some embodiment, as a button or some other selectable user interface item, selection of which causes the system to visually identify the key evidence requirements on the interactive map by updating the interactive map accordingly, In some embodiments, visual indicators corresponding to the lo-key evidence requirements are removed from the interactive map. In some other embodiments, however, a layer is superimposed over the map so as to identify/emphasize visual indicators corresponding to the priority (key) evidence requirements.

Which evidence requirements are classified as the key requirements may differ for different users and/or different system implementations. In some embodiments, the evidence assessment system includes settable parameters to enable its users to define criteria of the key requirements. Generally, the key requirements identify the key vulnerabilities for a particular user, such as areas in which the user would need to focus most and/or immediate effort. They are defined by, for example, deadline(s) associated with project(s) linked to the evidence requirement, the magnitude of the required evidence that need to be gathered, preference for a particular market (agency), importance of associated projects, how many evidence requirements the completion of a particular project helps to satisfy, and the like/others.

In the exemplary embodiment of FIG. 8A, only three statuses are used to indicate the level (status) of the ability of the evidence to satisfy a particular evidence requirement, e.g., not satisfied, partially satisfied, satisfied. However, fewer or more evidence statuses may be used.

Not every agency-domain combination necessarily has corresponding evidence requirements. In particular, agencies generally may have different requirements, and thus not each agency is mapped to all the domains and a particular agency may not have any requirements corresponding to one or more domains. In such a situation, in some embodiments, the status map 800 does not include any indicators for such an agency-domain combination, e.g., as indicated by item 850 in FIG. 8A. In some embodiments, the status map 860 includes special visual indicators to identify agency-domain combinations (pairs) that have no corresponding evidence requirements that need to be satisfied.

The interactive visual indicator 830 indicates a status of the evidence requirements for a particular agency-domain combination. Typically, a domain-agency combination has a plurality of associated evidence requirements. As the user proceeds with the gathering of the evidence, different evidence requirements may have different statuses for respective evidence for a particular agency-domain combination. For example, as shown in FIG. 8A, some agency-domain combinations have evidence requirements of each of the available statuses, such as 830₁, 830₂, 830₄, and 830₆. Some agency-domain combinations have two associated statuses, such as 830₃ and 830₆, while some agency-domain combinations have only one associated status, such as 830₅. Thus, the visual indicator may include one or more respective evidence status indicators.

Further, as shown in some embodiments, each evidence status indicator included within a particular visual indicator is represented in such a manner so as to indicate a proportion of evidence requirements for the corresponding agency-domain combination that has the associated evidence status. For example, the visual indicator 830₄ includes three status indicators 832₁, 832₂, and 832₃ corresponding to 8, 2, and 4 evidence requirements respectively. However, a proportion of evidence requirements of a certain status may be indicated in any other suitable manner, as long as it is easily observable to the user. For example, a visual indicator in a form of a pie chart with pies corresponding to the respective evidence statuses may be used. Further, a number of the evidence requirements corresponding to the particular status may be expressly shown. Further, to indicate different evidence statuses, different colors, patterns, opacity levels, shapes, and/or the like may be used to form the status indicators.

As discussed herein, the status map 800 is an interactive map. When the user selects a particular status indicator 832, corresponding user requirements are displayed to the user. For example, a table 840, including evidence requirements 842, status explanations 842, recommendations 846 for improving the status, and associated projects 848 may be displayed. Further, in some embodiments, when the user selects a particular agency 820 or a particular domain 810, the user is provided with a list of all evidence requirements corresponding respectively to the agency 820 or the domain 810. Such a list may further include respective statuses, status explanations, recommendations, and/or projects.

FIG. 8B depicts an example of the status map 800 with an expanded view, according to some embodiments. In particular, when a user selects a particular visual indicator, e.g., a visual indicator 830₁, in some embodiments, the user is provided with an expanded view of the visual indicator, such as an expanded view 870. In some embodiments, the expanded view is simply an enlarged representation of the visual indicator, for example, so as to ease the user's selection of a particular status indicator such as when the user uses touch gestures to make the selection. In some other embodiments, the expanded view provides additional information concerning the status indicators of the visual indicators, such as a specific number of evidence requirements corresponding to the particular status indicator. The user is able to select a particular status indicator in the expanded view to access further details associated with the selected status indicators, such as the associated evidence requirements, status explanations, recommendations, and/or projects. Yet in some embodiments, the expanded view not only provides an enlarged view of the visual indicator and/or additional information associated with the indicator, but also takes a different shape to provide the user with a different visual perspective of the same data, e.g., a pie chart instead of a rectangularly shaped visual indicator, such as shown in FIG. 8B.

In some embodiments, the expanded view provides a more detailed view of the corresponding visual indicator, such as shown in FIG. 8C. In such embodiments, the status map 800 initially provides for a broader overview of the evidence readiness the evidence statuses are defined on a broader level (e.g., satisfied, in progress, not satisfied). Thee expanded view however provides a more detailed view of the evidence readiness—the evidence statuses are defined on a more detailed level (e.g., satisfied, 70% satisfied, 50% satisfied, 30% satisfied, not satisfied). Thus, by selecting a particular visual indicator, e.g., the visual indicator 830, the user is able to see a more detailed view of the evidence statuses in the expanded view 890 of the visual indicator 830₁. In the illustrative embodiment of FIG. 8C, the expanded view 870 provides assessment of the evidence for the agency-domain combination and its evidence requirements in accordance with five (5) statuses instead of three (3) statuses used to grade evidence for the status map 800.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

The order of execution or performance of the operations in the embodiments illustrated and described herein is not essential, unless otherwise specified. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

Although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

1. A computer-implemented method for assessing evidence, the method comprising:
receiving a user request to summarize an ability of the evidence to satisfy agency requirements of one or more agencies, each of the one or more agencies having a plurality of evidence requirements categorized into one or more domains of a plurality of pre-defined domains;
for each combination of (1) an agency from the one or more agencies and (2) a domain from the plurality of the domains, wherein the domain comprises at least one evidence requirement of the agency,
generating a visual indicator reflecting the ability of the evidence to satisfy the at least one evidence requirement of the agency in the domain; and
rendering, on a display device, an interactive map comprising the generated visual indicators arranged by agencies and domains, the interactive map configured such that a selection of a visual indicator on the interactive map causes information related to the visual indicator to be rendered on the display device.

2. The computer-implemented method of claim 1, further comprising:
detecting selection of one or more criteria in at least one filter rendered along the interactive map;
and updating a rendition of the interactive map in accordance with the selected one or more criteria.

3. The computer-implemented method of claim 2, wherein the updating comprises:
superimposing an overlay layer over the interactive map to indicate one or more visual indicators corresponding to the selected one or more criteria.

4. A computer-implemented method of claim 2, wherein the at least one filter comprises at least one of:
a filter allowing the user to filter the interactive map to include only one or more selected agencies,
a filter allowing the user to filter the interactive map to include only one or more selected domains,
a filter allowing the user o filter the interactive map to emphasize information of a selected priority, or
a filter allowing the user to filter the interactive map to include information in relation to only a selected range of evidence requirements.

5. A computer-implemented method of claim 1, wherein each of the visual indicators included in the interactive map comprises one or more status indicators, each status indicator reflecting a status of the ability of the evidence to satisfy a subset of the at least one evidence requirement of the agency and domain combination corresponding to the visual indicator.

6. A computer-implemented method of claim 5, wherein at least one of the visual indicators included in the interactive map comprises a plurality of different status indicators, each of the different status indicators reflecting the status of the ability of the evidence to satisfy a different subset of at least one evidence requirement of the agency and domain combination corresponding to the at least one visual indicator.

7. A computer-implemented method of claim 6, wherein each of the plurality of different status indicators is designed to reflect visually a proportion of corresponding evidence requirements in the at least one evidence requirement of the agency and domain combination corresponding to the at least one visual indicator.

8. A computer-implemented method of claim 6, wherein the at least one visual indicator is one of:
a rectangle comprising a plurality of different portions, each portion representing one of the different status indicators, or
a pie chart comprising a plurality of different slices, each slice representing one of the different status indicators.

9. A computer-implemented method of claim 5, further comprising:
detecting a user selection of a visual indicator on the interactive map.

10. A computer-implemented method of claim 9, further comprising:
rendering, on the display device, at least one of:
the subset of evidence requirements corresponding to a status indicator selected in the visual indicator,
an explanation of how the status of the ability of the evidence to satisfy a respective evidence requirement was determined for one or more evidence requirements from the subset of the evidence requirements,
a recommendation concerning improving the status of the ability of the evidence to satisfy one or more evidence requirements from the subset of the evidence requirements, or
one or more projects corresponding to one or more evidence requirements from the subset of the evidence requirements.

11. A computer-implemented method of claim 10, further comprising:
rendering, on the display device, in response to a selection by a user of a project from the one or more projects, all evidence requirements from the plurality of evidence requirements that are linked to the project to be performed.

12. A computer-implemented method of claim 9, further comprising:
rendering, on the display device, an expanded view of the selected visual indicator.

13. A computer-implemented method of claim 12, wherein:
the expanded view is at least one of: an enlarged view of the selected visual indicator or a more detailed view of the selected visual indicator; and
the expanded view comprises a plurality of expanded status indicators, each expanded status indicator reflecting a status of the ability of the evidence to satisfy a subset of the at least one evidence requirement of the agency and domain combination corresponding to the selected visual indicator.

14. A computer-implemented method of claim 13, wherein (1) the plurality of the expanded status indicators directly correspond to the one or more status indicators.

15. A computer-implemented method of claim 13, wherein
each of the one or more status indicators is mapped to one of he plurality of the expanded status indicator; and
a number of expanded status indicators is greater than a r umber of he status indicators.

16. A computer-implemented method of claim 12, wherein the expanded view provides a more detailed breakdown concerning the ability of the evidence to satisfy evidence requirements than the visual indicator.

17. A computer-implemented method of claim 12, wherein the expanded view identifies a number of evidence requirements corresponding to each status indicator.

18. A computer-implemented method of claim 12, further comprising:
rendering, on the display device, at least one of:
a subset of evidence requirements corresponding to a status indicator selected in the expanded view,
an explanation of how the status of the ability of the evidence to satisfy a respective evidence requirement was determined for at least one evidence requirement from the subset of the evidence requirements,
a recommendation concerning improving the status of the ability of the evidence to satisfy at least one evidence requirement from the subset of the evidence requirements, or
a list of projects corresponding to at least one evidence requirement from the subset of the evidence requirements.

19. A computer-implemented method of claim 18, further comprising:
receiving a request, from the user, to update at least one of: a status of the ability of the evidence to satisfy an evidence requirement from the subset of evidence requirements rendered at the display device, a status explanation. or a project linked to the evidence requirement;
updating relevant data responsive to the request; and
logging the request and associated changes in association with the request to store as a history.

20. A computer-implemented method of claim 19, further comprising:
prompting the user to update the status explanation the user request is a request to update the status: and
transmitting to a predefined entity, a request to approve the user request,
wherein the relevant data is updated if an approval of the user request is received from the pre-defined entity.

21. A graphical user interface for assessing user evidence on a user device with a display, comprising:
a summary request functionality that enables a user to submit a request to summarize an ability of the evidence to satisfy evidence requirements of one or more agencies, each of the one or more agencies having a plurality of evidence requirements categorized into one or more domains of a plurality of pre-defined domains;
an interactive map comprising, for each combination of (1) an agency from the one or more agencies and (2) a domain from the plurality of the domains, wherein the domain comprises at least one evidence requirement of the agency,
a visual indicator reflecting the ability of the evidence to satisfy at least one evidence requirement of the agency in the domain, the visual indicators arranged by agencies and domains; and
an interactive functionality that enables the user to select a visual indicator on the interactive map and receive information related to the selected visual indicator to be rendered on the display device.

22. A computing device, comprising:
a display;
one or more processors
memory; and
one or more programs stored in the memory and configured to be executed by the one or more processors to perform a method comprising:
receiving a user request to summarize an ability of the evidence to satisfy agency requirements of one or more agencies, each of the one or more agencies having a plurality of evidence requirements categorized into one or more domains of a plurality of pre-defined domains;
for each combination of (1) an agency from the one or more agencies and (2) a domain from the plurality of the domains, wherein the domain comprises at least one evidence requirement of the agency,
generating a visual indicator reflecting the ability of the evidence to satisfy the at least one evidence requirement of the agency in the domain; and
rendering, on a display device, an interactive map comprising the generated visual indicators arranged by agencies and domains, the interactive map configured such that a selection of a visual indicator on the interactive map causes information related to the visual indicator to be rendered on the display device.
